(19) United States
(12) Patent Application Publication
(10) Pub. No.: US 2017/0228752 A1
(43) Pub. Date: Aug. 10, 2017

(54) DETERMINING AND OFFERING CONTEXT BASED REWARDS

(71) Applicant: MasterCard International Incorporated, Purchase, NY (US)

(72) Inventors: Brien Buckman, Stamford, CT (US); Benjamin Alexander Flast, New York, NY (US)

(21) Appl. No.: 15/018,164

(22) Filed: Feb. 8, 2016

(51) Int. Cl. G06Q 30/02

(52) U.S. Cl. CPC G06Q 30/0207; G06Q 30/0267

(57) ABSTRACT

A method includes receiving from a mobile device context data derived from one or more sensors, determining the occurrence of a trigger based, at least in part, upon the received context data, utilizing the context data and at least one purchase datum to determine a reward and transmitting the reward to the mobile device.

### BACKGROUND

Field

The present application generally relates to determining and offering context-based rewards. In particular, the present application relates to establishing user context at a mobile device via a plurality of sensors, determining the occurrence of a context based trigger and merging purchase data, including, without limitation, payment card transaction data with the user context to provide a reward to the user.

Related Art

Mobile devices are capable of sensing various contextual variables and attributes of a use environment of the mobile device. Such contextual information may be used in various ways to target a user of the mobile device with information pertinent to the user, such as reminding the user to remain active, or perform a task at a specified location. Separately, relevant archived information, such as user purchase information may be used to suggest items for purchase. The relevant archived information is not necessarily related to the present user context, but which may provide the ability to better target the user with information of interest to the user.

### SUMMARY

In accordance with an exemplary and non-limiting embodiment, a method comprises receiving from a first application executing on a computing device context data derived from a plurality of mobile device-resident sensors, the context data derived on a mobile device by a second application executing on the mobile device, wherein the first application gathers mobile device context for a portion of the plurality of sensors from an operating system of the mobile device and for at least one of the plurality of sensors from the second application, accessing an archive in a non-transient computer accessible memory of transaction data for a user of the mobile device, determining the occurrence of a trigger based, at least in part, upon an association of the received context data with the accessed archived transactional data, utilizing, in response to the occurrence of the trigger, the context data upon which the occurrence of the trigger was based and at least one purchase datum of the archive to determine a reward and associating the reward to a user identifier.

The context data is from one or more sensors in communication with the mobile device. These one or more sensors are selected from the group consisting of a location sensor, a motion sensor, an image sensor, an audio sensor, a biometric sensor, an environmental sensor, an accelerometer, an ambient temperature sensor, a gravity sensor, a gyroscope, a light sensor, a linear acceleration sensor, a magnetic field sensor, an orientation sensor, a pressure sensor, a proximity sensor, a relative humidity sensor, a rotation vector sensor, a barometer, a pedometer, a heart rate sensor, a finger print sensor, a radiation sensor, a wireless enabled sensor, and the like. Certain sensors may be listed herein, but sensors contemplated for this disclosure also may include sensors that perform certain categories of functions, such as sensing an environment of the phone (e.g., temperature, humidity, altitude, and the like) or providing an indication of a situation of the device, such as if the device is moving, stationary, oriented vertically, laying flat, and the like.

The at least one of the first and second applications is a long running application.

The context data is derived from an operating system of the mobile device, optionally through an application programming interface.

Determining the occurrence of a trigger involves the steps of: comparing the context data to one or more instances of previously classified context data; assigning at least one classification of the previously classified context data to the context data; and determining the occurrence of the trigger based, at least in part, upon the assigned classification. The previously classified context data is classified via manual tagging or artificial intelligence.

Utilizing the context data and at least one purchase datum to determine a reward includes applying reward logic to the context data and at least one purchase datum to determine a reward. The reward logic may include an equation, may be defined manually, may be defined via artificial intelligence, and the like. The reward may be determined based at least in part on the financial interests of a credit issuer who may, optionally, exercise control over the purchase data.

In accordance with an exemplary and non-limiting embodiment, a method comprises deriving, at a mobile device, context data from data captured by a plurality of sensors of the mobile device, determining the occurrence of a trigger based, at least in part, upon the derived context data, transmitting the context data, and data indicative of a user of the mobile device to a server configured to associate the context data with archived transaction data of the user, receiving a reward from the server wherein the reward is based, at least in part, upon the association of the context data with at least one purchase data of the archived transaction data and displaying the reward to the user.

The plurality of sensors is selected from the group consisting of a location sensor, a motion sensor, an image sensor, an audio sensor, a biometric sensor, an environmental sensor and a wireless enabled sensor.

The receiving at the mobile device is performed by an application executing on the mobile device. The application is optionally a long running application.

The context data is derived from an operating system of the mobile device, optionally through an application programming interface.

Determining the occurrence of a trigger involves the steps of: comparing the context data to one or more instances of previously classified context data; assigning at least one classification of the previously classified context data to the context data; and determining the occurrence of the trigger based, at least in part, upon the assigned classification. The previously classified context data is classified via manual tagging or artificial intelligence.

In accordance with an exemplary and non-limiting embodiment, a system comprises a mobile device configured to receive context data from one or more of its sensors, determine the occurrence of a trigger based, at least in part, upon an association of the context data and archived transaction data for a user of the mobile device, transmit the context data to a server and receive from the server information describing an offer for presentation via a user interface of the mobile device and a server configured to receive the context data from the mobile device, to combine the context data with purchase information to determine a reward and to transmit the reward to the mobile device.

### BRIEF DESCRIPTION OF THE FIGURES

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is an illustration of a system architecture according to exemplary and non-limiting embodiments;

FIG. 2 is a flowchart of a method according to exemplary and non-limiting embodiments.

FIG. 3 is an illustration of the flow of data according to an exemplary and non-limiting embodiment.

FIG. 4 depicts a deployment environment of the methods and systems described herein.

### DETAILED DESCRIPTION

In accordance with exemplary and non-limiting embodiments, methods and systems are described whereby purchase data is combined with mobile device sensor-derived context data, which may relate to a user or the device, to trigger one or more rewards or offers. The terms offer, reward, award, incentive, discount and coupon are used interchangeably herein, except where context indicates otherwise.

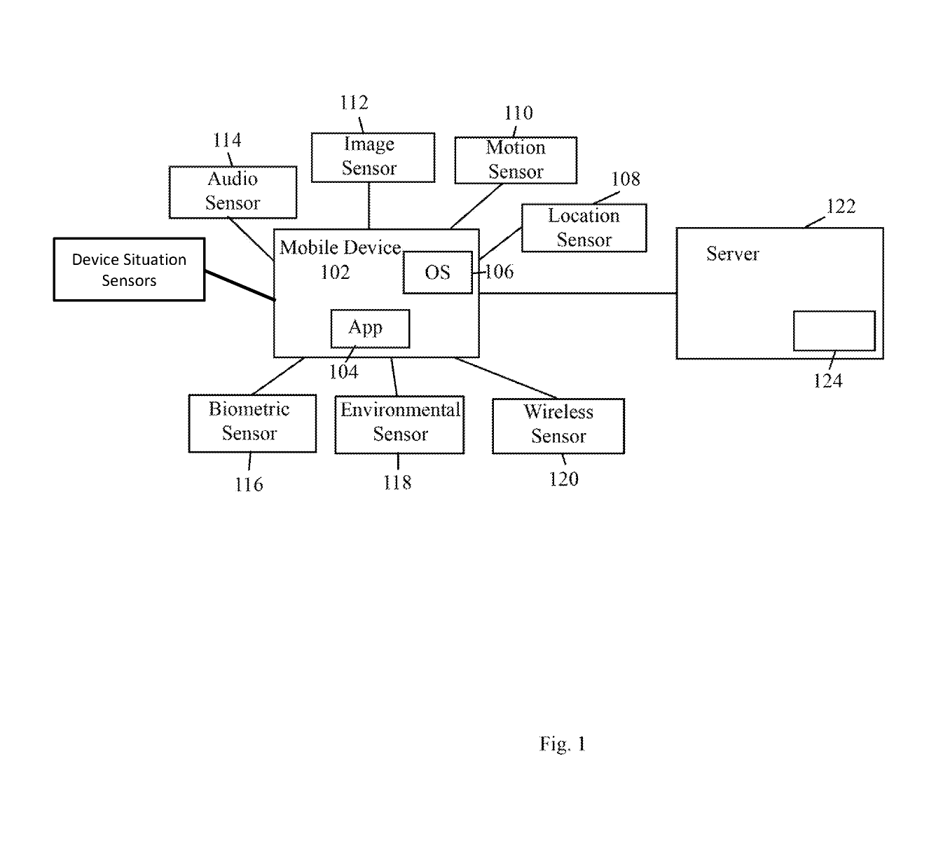

With reference to FIG. 1, there is illustrated a system 100 according to an exemplary and non-limiting embodiment. A mobile device 102 is configured to collect sensor data. As used herein, “mobile device” refers to any and all electronic devices configured to be operated while being carried or otherwise transported by a user of the device including, but not limited to, a smart phone, cell phone, a personal digital assistant (PDA), a tablet PC, laptop, watch, portable music player, and the like.

The mobile device 102 may be configured with one or more sensors for sensing, monitoring, recording and communicating environmental data descriptive of the environment in proximity to the mobile device including, for example, data descriptive of the activities and physical and mental states and status of the user.

The mobile device 102 may be configured with an image sensor 112 including, but not limited to, a camera or cameras. In exemplary and non-limiting embodiments, such cameras may be configured to record images, stereo images, infrared (IR) images, as well as any other image type. The mobile device 102 may be configured with an audio sensor 114 to facilitate capturing sound in proximity to the mobile device 102. An exemplary sensor 114 may be configured to detect and record audio and/or acoustic data. In exemplary and non-limiting embodiments, such audio sensors 114 may take the form of one or more microphones. The mobile device 102 may be configured with a motion sensor 110 to facilitate detecting and monitoring movement near or of the mobile device and, by extension, user movement. In exemplary and non-limiting embodiments, such motion sensors 110 may take the form of one or more accelerometers or gyroscopes. The mobile device 102 may be configured with a location sensor 108 including, but not limited to, a GPS sensor. In exemplary and non-limiting embodiments, such location sensors may be configured to determine a geographic location of a user. The mobile device 102 may be configured with a biometric sensor 116. In exemplary and non-limiting embodiments, such biometric sensors 116 may be configured to record biometric data descriptive of a user including, but not limited to, heart rate, temperature, galvanic skin response, and the like. The mobile device 102 may be further configured with an environmental sensor 118. In exemplary and non-limiting embodiments, such environmental sensors 118 may be configured to record environmental data descriptive of a user's environment including, but not limited to, temperature, humidity, altitude, air pressure, ambient light, presence of other mobile devices and the like. In addition, the mobile device 102 may be wirelessly connected to one or wireless enabled sensors.

As described more fully herein, there may be resident on the mobile device 102 one or more applications, or “Apps”, 104 as well as an operating system, or “OS”, 106. The mobile device 102 may be configured to communicate with a server 122. The server 122 and/or the mobile device 102 may be configured to store upon and access data from a database 124.

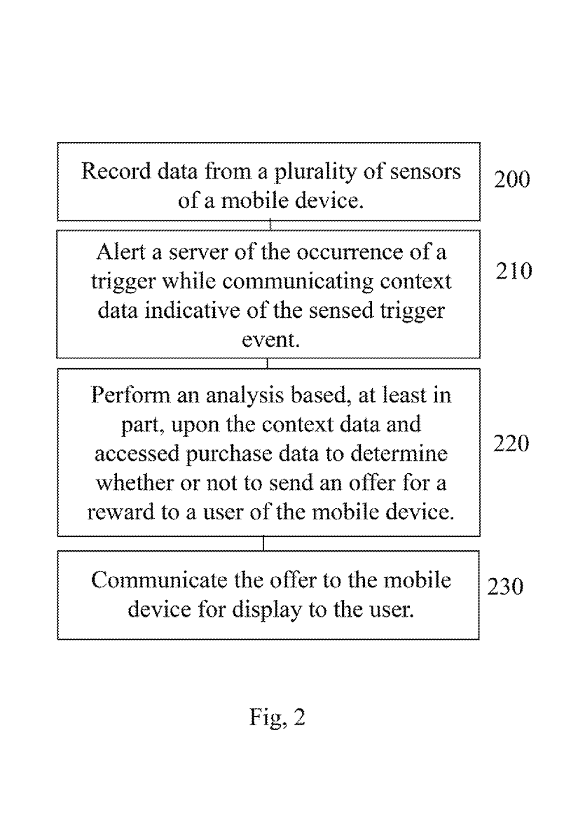

With reference to FIG. 2, there is illustrated a flow chart of an exemplary and non-limiting embodiment. At step 200, an application 104 executing on a mobile device 102 records relevant data from the plurality of sensors 108-120. Next, at step 210, when a sensed event is determined to comprise a trigger, the application 104 alerts the server 122 of the occurrence of the trigger while communicating context data indicative of the sensed trigger event. In some exemplary embodiments described more fully below, the server 122 may determine the occurrence of a trigger based, at least in part, on context data sent from the mobile device 102 to the server 122. In yet other exemplary embodiments, sensor data may be transmitted to the server 122 whereat sensor-based context may be derived and an occurrence of trigger thereby determined. Next, at step 220, the server 122 performs an analysis based, at least in part, upon the context data and accessed purchase data to determine whether or not to send an offer for a reward to a user of the mobile device 102. Lastly, at step 230, the server 122 communicates the offer to the mobile device 122 for display to a user.

With specific reference to step 200, as described above, an application 104 executing on a mobile device 102 records meaningful data from the plurality of sensors 108-120. In addition to raw sensor data that may be accessed and processed by the application 104 or other middleware executing on the mobile device 102, information derived from the sensors 108-120 may likewise be accessed directly from the operating system 106 resident and executing on the mobile device 102. Examples of operating systems include, but are not limited to, Android and iOS. Such operating systems may operate to receive sensory inputs from the mobile device 102 and to derive user characteristics therefrom. Once derived, the user characteristics may be queried via an application program interface (API) such as a public API. The operating system 106 may receive accelerometer data over a period of time from the mobile device 102 that may be determined to be associated with or otherwise indicative of physical activity by the user. More specifically, the operating system 106 may classify one or more accelerometer readings as corresponding to a physical or mental state of the user. For example, the operating system 106 may classify an activity profile comprised of recorded accelerometer readings as corresponding to a period of time during which the user was running. Similarly, the operating system may conclude from sensor readings, such as from the motion sensor 110 and/or the biometric sensor 116 that a user has just finished running or is at rest.

As noted above, determinations of user context such as, for example, data indicative of a present or past mental or physical state of the user, may be made by the operating system 106 and provided to an external requesting application 104 such as via a public API. In addition, software external to the operating running on the mobile device 102 such as, for example, application 104 or middleware, may categorize and/or classify sensor information into data indicative of a user context. To facilitate gathering and deriving context from mobile device sensors, which generally operate on a continuous basis, application 104 may preferably be configured to operate as a long running service (e.g., a service or application that operates continuously over a very long period of time, such as longer than a week or more, even when other applications are not active). Such a long running application may facilitate processing sensor data over several days or longer to facilitate detecting context that may be indicative of a trigger condition. Long running applications may facilitate maintaining frequent updating of context for a range of potential sensor data-based trigger conditions over extended periods of operation of the mobile device. Alternatively, application 104 may operate over shorter periods of time, such as in embodiments in which sensor data or context is processed by a remote server to determine, among other things, possible reward trigger conditions indicated by the sensor data. In accordance with exemplary and non-limiting embodiments, an application 104 may access a database 124, as may be stored on the mobile device 102 or accessible via an external server 122, in order to classify sensor data as context data.

With specific reference to steps 210 and 220, above, the mobile device 102 may capture ambient acoustic data. Capturing may be performed continually, intermittently, based on output of one of the other sensors, based on a state of the mobile phone, based on mobile phone application activity or periodically. This acoustic data, or data derived from the captured acoustic data may then be classified. The data may be classified by the mobile device or sent to the server 122 for classification. In such instances, the database 124 may be seeded with samples for statistical comparison with the acoustic data. For example, the mobile device 102 of a user in a bar may record one or more samples of sound recorded at the bar. These samples may then be sent to the server 122 whereat the sound is compared in a database 124 seeded with various tagged samples of environmental sounds corresponding to identified environments. As a result, the server 122 may classify the received acoustic data as corresponding to a bar environment. As described more fully below, this environmental context data may be used to determine a reward to be offered to the user.

Sensor data from mobile device sensors may further be used to determine a way of presenting an offer. In an example, a user of a mobile phone to which an offer is to be presented may be determined, through sensor context of its sensors, to be running or driving. Providing a text message of the offer may not be optimal in this situation, so the delivery of the offer may be adjusted based on context derived from the sensors, such as contemporaneously with a time when the offer may be presented. In this example, an audio message may be provided instead of a text message. Likewise, a timing for delivery of an offer may be impacted by context derived from the device sensors. In an example, mobile device sensors may indicate that the user is executing a sky dive. The presentation of an offer may be delayed until after the sensors indicate that the user has safely landed. In another embodiment, it may be determined that the user is in a noisy environment, such as a bar or sporting event, so the offer is provided visually rather than as an audio message.

The methods and systems for detecting sensor-based trigger conditions that may indicate an opportunity for presenting a reward to a user of a mobile device may be used in a variety of environments and with a variety of data sources. One exemplary environment may include combining data from a user's social network content and/or calendar (e.g., a user posted that he is attending a country music concert) with sensor data from the user's mobile device (e.g., audio through the mobile device microphone that indicates the user is listening to country music, wireless network sensor data indicating the user is in proximity to a particular music venue's WiFi network, and the like) to indicate that the user is attending the posted concert. This type of context classification may indicate a trigger for offering the user rewards associated with his current environment. An offer may be determined based on the user's transaction history of purchases made by the user associated with the country music band and/or offers made to the user at earlier concerts. In this way, not only can transaction history be useful for offer selection, but prior reward activity and in particular similar reward activity (e.g., at earlier concerts, prior offers associated with the current country music band, and the like) can be combined with mobile device sensor data to make an offer of a reward to a user. Additionally, real-time offer activity of other users attending the concert may be combined with the particular user's mobile device sensor data to determine an offer to present. As an example, if the user has a transaction history of purchasing a tee-shirt at the end of several concerts, and purchase activity of other users at the concert suggest that a high number of t-shirts are being purchased, the user may be presented with an offer to pre-purchase a tee-shirt during the concert to avoid missing the opportunity to do so after the concert.

Similarly, image data collected by an image sensor 112 of the mobile device 102 may be compared to a database 124, either at the mobile device 102 or at the server 122, in order to identify and classify an environmental context for the user. For example, a user may take a picture or video of friends on a beach with a camera forming a part of mobile device 102. The captured image data forming the photo may be sent to the server 122 for analysis to determine an environmental classification of the locale depicted in the photo. In the present example, the server 122 may classify the photo as representing a beach environment. In some embodiments, sensor data such as audio and image data, may be preprocessed at the mobile device 102 prior to transmission to the server 122, such as to protect the privacy of the user. For example, an application 104 on the mobile device 102 may process the image data to create a statistical description of the image detailing various attributes of the image data but from which the image data cannot be recreated. Such descriptive data may then be sent to the server 122 for analysis. In this manner, the user may keep the details of the image data private while enabling context classification based, at least in part, upon the image data.

Data from a plurality of mobile device sensors may be combined into a multi-sensor context of the mobile device. This combined sensor context may be classified. In an example, two users may be attending a concert. One user is sitting in the audience and the other is actively participating in a mosh pit. While the audio and video may be comparable between the two users, combining the motion sensor data may result in substantively different context classifications for the two users.

Data from a plurality of mobile devices may also be combined into a multi-sensor, multi-device context. This may be done through similarity in sensor data (e.g., similar GPS location, audio, video and the like) in a near real-time application. However, this may be done for users whose mobile device sensors provide substantively different data, such as if the two users are physically distant, doing different activities. Through analysis of transaction data, social media data, and other data that may be available, it may be determined that the users are associated in such a way that combining their data may be beneficial for the purposes of presenting awards. In an example, location and network data may indicate that two users likely work in the same office, e.g., based on the location data and network data indicating that the two devices are located proximal and within range of a common Wi-Fi network most weekdays. In such a situation, analyzing transaction history of one user may facilitate making better office supply offers to the other user. Similarly, if social media suggests that these two co-workers are both fans of the same sports team and one user has accepted an offer to purchase tickets to an upcoming team event, an offer to purchase event tickets may be made to the other user. Such an offer may be made without reference to the other user, or may be made with specific reference to further enrich the offer context.

In an exemplary embodiment, context classification based, at least in part, upon mobile device sensor data may be performed utilizing artificial intelligence. Such artificial intelligence may be trained over time on volumes of data to better identify and classify sensor derived data according to context. In some exemplary embodiments, such training may be specific to a volume of sensor data from a particular user in order to optimize the context classifications for the specific user.

In accordance with an exemplary and non-limiting embodiment, collection of sensor data may occur at predefined intervals or in response to discrete events, such as taking a photo, calling a friend, making a purchase, entering a geo-fenced area, etc. In some embodiments, the server 122 may communicate with the mobile device 102 to request additional sensor data.

Collection of sensor data may occur from a plurality of devices associated with a user. The sensor data may be collected from multiple devices (e.g., a smart phone, a smart watch, a laptop, a wearable fitness device and a digital music player). The collection may be performed simultaneously, contemporaneously, chronologically, asynchronously, in a coordinated manner, or over time from different devices. As an example, sensor data may be collected over time from a personal phone, a smart watch, a digital music player, a wearable electronic device, smart clothing, and the like. In another example, sensor data may be collected from a phone when the phone is detected to be in proximity to the user, and from a different device that is detected to be in proximity to the user when the phone is not detected to be in proximity of the user. Combinations of sensor data from different devices, both near real-time and accumulated over time may be used to determine user context for generating and presenting offers.

Regardless of the method by which sensor data is acquired, optionally combined and classified by context, once classified, the derived mobile device and/or user context may serve as a trigger for determining and offering a reward to a user. As noted, the trigger may be a result of a combination of purchase data with the user context data. Such a trigger may facilitate determining a reward to be offered to the user.

For example, an application may receive data from a motion sensor 110 of the mobile device 102 indicating that the user has been running. Such data may be received directly from the sensors by the application 104 or may be received via an API query to the operating system 106 of the mobile device 102. Once classified as running behavior, the user context information may be transmitted to the server 122. Alternatively, sensor data may be collected and transmitted to the server 122 independent of the presence of the application 104 on the mobile device. Once received at the server, context may be derived and such context may be classified, as described herein, by the server 122. The server 122 may have access to archived user context data such as may be stored in the database 124. The database 124 may be located local to the server 122 or remote from the server 122 and accessed over a network. Also, the database 124 may comprise a plurality of physically separated databases, such as one that is local to the server 122 and another that is remote from the server 122. In the present example, the server 122 may access data indicating that the user has been running a good deal recently. Using the running information as a trigger, it may be determined by the application 104 and/or at the server 122 that a reward is to be offered to the user and the reward may be associated with a user identifier. The reward to be offered may be based on additional context and archived transaction activity of the user. As an example, the amount of running over a period of time may trigger the need for an offer; however, the availability of suitable offers (e.g., new running shoes) in proximity to the user (e.g., based on a current location of the user and/or archived user context that suggests the user passes a particular shoe store on a regular basis) may influence the nature and timing of an offer. A set of offering rules may indicate that offers for running shoes are preferably made when the user is taking a route nearby the particular shoe store and the user does not have any calendar activity for at least 30 minutes from the time at which the user is expected to be proximal to the particular shoe store.

In accordance with exemplary and non-limiting embodiments, once triggered, the user context information, in this case, evidence of recent running coupled with a history of running, may be combined with purchase data to determine a reward. For example, the server 122 may access a database 124 containing purchase information to find that the user recently bought a new pair of running shoes. As is described more fully herein, the coupling of the user context data and the purchase information may, in this example, result in the server transmitting an offer, at step 230, to buy new shoes at a discount to the mobile device 102 for display to the user.

The following example describes a technique for reward triggering based, at least in part, upon a combination of a sensor output that indicates a geographic location of a user's device and transaction history for the user and other users. As an initial indication, the mobile device 102 or the server 122 determines based, at least in part, upon data received via the location sensor 108, that a user is at a shopping mall. As a result, the user's sensor-specific context data is classified as being at a mall or retail facility. Using this classified context data as an initial indication of a potential trigger, the mobile device application 104 and/or a reward determination application executing on the server 122 may combine the determined context data with purchase information to determine a reward for offer. In the present example, the server 122 accesses data from the database 124 indicating that the user purchased a computer. The server 122 may further determine, from analysis of the data from the database 124 that the user has not purchased certain computer accessories that other users commonly purchase within a timeframe that is similar to the time since the user purchased the computer. The server 122 may analyze information regarding retailers in the mall to determine which retailer(s) may be in a position to offer some sort of discount or reward for one or more of the computer accessories identified by the server 122. Based on this analysis of sensed user location, proximity of retailers, purchase history of the user (e.g., purchasing the computer but not the accessories), purchase history of other users (e.g., certain accessories), and potential retailer participation in a reward, a reward is generated and transmitted to the mobile device 102 allowing the user to obtain, for example, discounted accessories for the computer at one or more identified stores in proximity to the user (e.g., in the mall where the user's mobile device sensors have indicated the user is located).

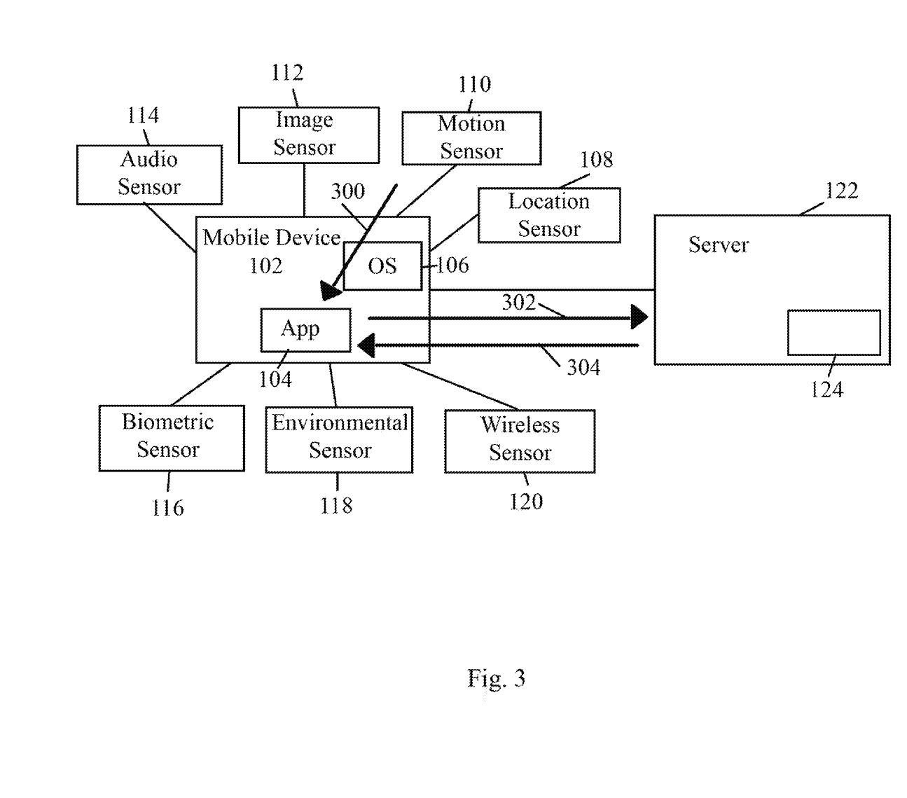

With reference to FIG. 3, there is illustrated the flow of data according to yet another exemplary and non-limiting embodiment wherein a user is purchasing drinks at a bar. Audio information sampled and received from a microphone of the mobile device 102 is sent to a long running application 104 along dataflow 300 and to the server 122 along dataflow 302. The server 122 compares the audio samples to a database seeded with classified audio samples. The server 122 determines, such as by a statistical calculation, the application of a neural network or the like, that the audio information is indicative of a bar environment and classifies the received audio information accordingly. Next, purchase data corresponding to purchases made by and associated with the user of the mobile device 102 is accessed, such as from the database 124, that indicates that the user is spending more and more time in between ordering drinks at the bar. As a result, the user's environmental context data, indicating presence at a bar, may be coupled with the drink purchase information, indicating an impending end to festivities, to produce an offer to be transmitted along dataflow 304 to the user at the mobile device 102 for a decreased taxi fare.

In yet another exemplary and non-limiting embodiment, a user has been out all day generating substantial context data based, at least in part, on his or her whereabouts, mode of transportation, and current location. This context data may include audio detected by the microphone of the user's mobile device that may include certain key phrases, such as the user remarking that he or she may need to buy more pretzels soon. The server 122 may analyze the purchase history of the user and determine that, based on prior purchases of pretzels, the user would not normally be in the market for more pretzels. However, based on these variables a business rule that determines when to offer the user a reward for pretzel purchase may be adapted so that a reward related to pretzels may be prepared for the user. A trigger condition for location data from the mobile device GPS sensor may be set by the server 122 so that when the mobile phone is next in proximity to a location where a pretzel-related reward may be beneficial to the user, the position trigger will be activated and a promotion for discounted pretzels will be presented to the user. In this way, the user obtains what he or she desires and at a great price whether he or she initially went to the store to get it or not. This example also suggests that combining mobile device-based sensor data with purchase history in a reward determination and generation rule-based environment may be quite effective if it includes use of multiple sensors and multiple triggering capabilities.

The logic utilized by the server 122 when matching a reward to the combined context data and purchase data may take the form of equations or quasi-equations equating context variables and context variable classifications to rewards. Such equations may be described, in exemplary embodiments, as having the general form of: context variable (X) (+) purchase variable (Y)=reward (Z). While described logically as comprising a single context variable, a single purchase variable and a single reward, in practice, such equations may make use of a plurality of each type of variable. For example, with reference to the running example described above, an equation may specify: context variable1(running)(+)context variable2(recent history of running)(+)purchase variable(shoes)=reward(discount on new pair of shoes).

In accordance with exemplary and non-limiting embodiments, the equations utilized as well as any other generalized logic for application in determining rewards regardless of the means of expression, may vary in generality and specificity. For example, reward logic may be expressed as: context variable(exercise) (+) purchase variable (sports equipment)=reward(discount on sports equipment). Such increased generality may be useful when either the context information or the purchase information is lacking in specificity. For example, in some instances, the sensor readings may not be sufficient to differentiate between running and other aerobic activities. In other instances, purchase information may be general in nature or may be incomplete. In such instances, more general reward logic may be utilized to match a reward to an observed context coupled with purchase data.

The logic employed to match context and purchase data to a reward may be created manually and stored in the database 124 for access by the server 122. In other exemplary and non-limiting embodiments, artificial intelligence may be employed to derive reward logic using databases of context data, purchase data, and rewards as inputs.

Rewards or offers may be determined through a decision tree process that may begin down a particular path and may change to an associated path based on updated context or trigger information. In this way, trigger context to reward determination may be dynamically adjustable based on context and other factors. Likewise, trigger conditions may be defined with relative priority so that higher priority triggers may be processed through to offers before lower priority triggers, even if a lower priority trigger occurs before the higher priority trigger.

Rewards may be associated, such as through a database or the like, with specific sensed inputs. A reward, a plurality of awards, or a type of reward may be associated in the database with one or more images, audio sounds and the like. In this way, when an image, for example, is detected via the image sensor facility of the mobile device, the server 122 may commence negotiation with third parties who may offer rewards that are determined to correspond to the detected image based on the association in the database. Alternatively, an offer may be selected from a set of existing rewards, such as from a database of rewards that may be pre-configured by vendors. Vendors may make rewards available to the reward determining server with or without additional compensation. In embodiments, vendors may make an offer to pay, or directly make a payment to have a reward included in such a database. Likewise, the corresponding reward type may be used as a key for analyzing a user's transaction history to determine if an offer that corresponds to the reward type is suitable for being offered to the user. Associations of sensor input data with offers, awards or award types may be learned through ongoing analysis of sensed input data and offer activity. When offers are successfully accepted by a user, an association between the sensor input and the offer may be strengthened. When offers are rejected, associations may be weakened. The database may track strength and/or weakness of associations of offers with sensor input.

In an exemplary and non-limiting embodiment, purchase information may be gathered and stored based, at least in part, upon credit card purchases or on e-commerce transactions, however implemented, associated with a user account, such as a transaction account, a credit account, a loyalty account, a debit account, and the like. In some embodiments, the nature and magnitude of remuneration, fee, profit or other financial benefit to a credit issuing agency or entity, such as an entity operating the trigger detection and reward offering methods and systems described herein may be taken into account when determining a reward. For example, a company that issues consumer credit, such as via consumer credit cards, may operate the server 122 to give preference to rewards that result in greater financial gain to the company. For example, if it is determined to provide an offer to a consumer for a discount off of the purchase of a new pair of shoes and it is further determined that there are two equally proximate stores at which the reward may be configured to be valid, preference may be given to offering redemption of the reward at the store that provides the greatest fee to the credit issuing company upon exercise of the reward.

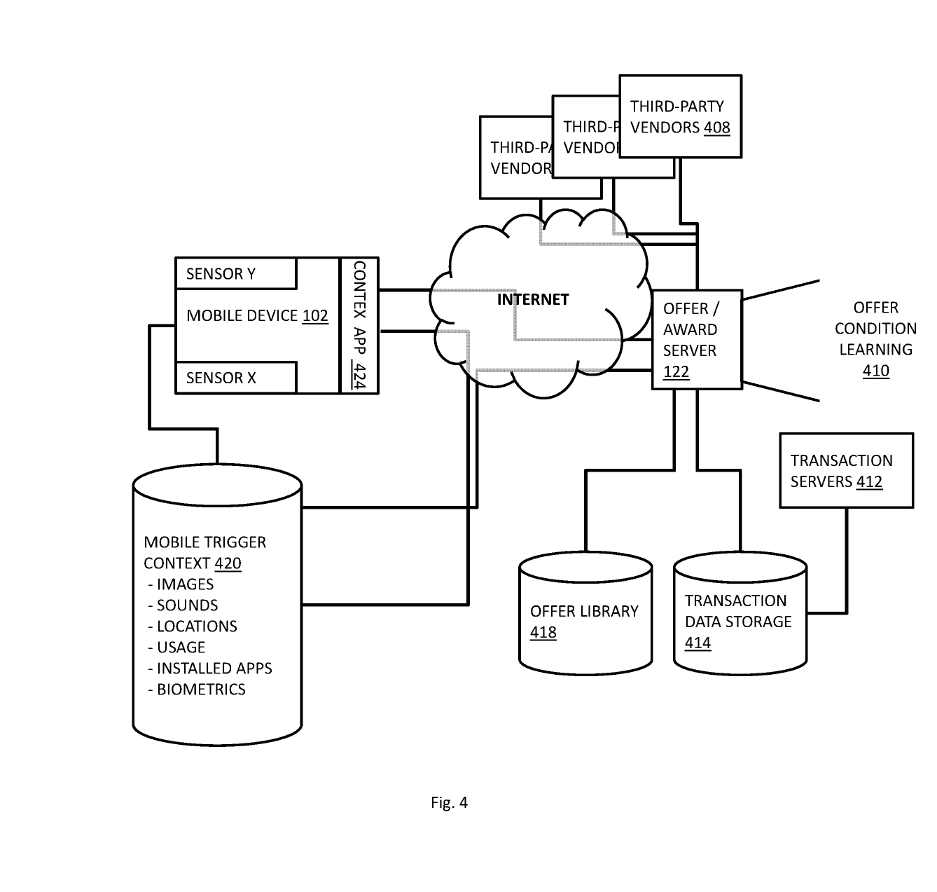

The methods and systems for detecting mobile phone sensor-based award/offer context and using such context to facilitate analysis of transaction history for at least a user of the mobile phone may be deployed in an environment as depicted, for example, in FIG. 4. A mobile device 102 configured with a context application 424 may communicate with offer award servers 122, mobile trigger context data storage and sources 420, and the like to facilitate award determination based in part on mobile device sensor data. A context app 424 may access mobile trigger context data from mobile trigger context storage facility 420 that may hold various key elements associated with determining when a mobile device sensor is producing a trigger condition. Example key elements may include images or metadata descriptive of portions of images that may be used with image data from an image sensor of the mobile device for generating a trigger to produce an offer or award based thereon. Other trigger context that may be accessed in mobile trigger context 420 may include key sounds to facilitate determining an offer/award trigger condition based on audio received by the mobile phone audio sensor. Other sensor-specific trigger context that may be configured and/or accessed in the mobile trigger context facility 420 may include locations (e.g., GPS sensor), biometrics (e.g., heart rate monitor), usage (e.g., motion sensors), and the like. Likewise the mobile trigger context 420 may be configured by the mobile device 102 and/or an offer/award server 122 to facilitate trigger detection.

Offer server 122 may communicate with a mobile device 102 through a context app 420 via a network, such as a cellular network, the Internet, and the like. Third party vendors 408 may also be contacted by the offer/award server 122 to facilitate offer development. Third party vendors may make offers and/or receive requests for offers that the offer server 122 may include or further negotiate with the third party vendors 408 to obtain a preferred offer, such as an offer that improves profit for an operator of the offer/award server 122, and the like. The offer server may run an offer auction, receiving bids from third party vendors for participating in offers. Offers that are accepted by the server 122, and offers for which an auction is concluded may be stored in an offer library 418 that may be accessible to the offer/award server 122, such as for easier access when a mobile device sensor-based offer preparation trigger condition is met.

Offer server 122 may also communicate with transaction data storage 414 that may comprise a portion of transactions conducted via the mobile device 102 and/or many other mobile devices. Transaction server 412 may include a plurality of servers connected to the transaction data storage facility 414 directly, through the Internet, or via a proxy, and the like. These transaction servers 412 may facilitate populating the transaction data storage facility 414 with mobile device and other transactions that may be useful to determine what type of offer can preferably be made.

Any data sets (e.g., mobile trigger context 420, offer library 418, transaction data storage 414, and the like) can be enhanced through machine learning techniques described herein. These techniques may facilitate improving trigger conditions, offer relevance, and the like. A server, such as offer/award server 122 may apply machine learning techniques, such as offer condition learning techniques 410 to achieve these improvements.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the described methods and systems. In addition, all the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the described methods and systems. In addition, all the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable transitory and/or non-transitory media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the methods and systems described herein have been disclosed in connection with certain preferred embodiments shown and described in detail, various modifications and improvements thereon may become readily apparent to those skilled in the art. Accordingly, the spirit and scope of the methods and systems described herein is not to be limited by the foregoing examples, but is to be understood in the broadest sense allowable by law.

All documents referenced herein are hereby incorporated by reference.

What is claimed is:

1. A method comprising:
receiving from a first application executing on a computing device context data derived from a plurality of mobile device-resident sensors, the context data derived on a mobile device by a second application executing on the mobile device, wherein the first application gathers mobile device context for a portion of the plurality of sensors from an operating system of the mobile device and for at least one of the plurality of sensors from the second application;
accessing an archive in a non-transient computer accessible memory of transaction data for a user of the mobile device;
determining the occurrence of a trigger based, at least in part, upon an association of the received context data with the accessed archived transactional data;
utilizing, in response to the occurrence of the trigger, the context data upon which the occurrence of the trigger was based and at least one purchase datum of the archive to determine a reward; and
associating the reward to a user identifier.

2. The method of claim 1, wherein the context data is comprised from one or more sensors in communication with the mobile device.

3. The method of claim 2, wherein the one or more sensors are selected from the group consisting of a location sensor, a motion sensor, an image sensor, and audio sensor, a biometric sensor, and environmental sensor and a wireless enabled sensor.

4. The method of claim 1, wherein at least one of the first and second applications is running in the background of the device.

5. The method of claim 1, wherein the context data is derived, at least in part, from an operating system of the mobile device.

6. The method of claim 5, wherein the context data is accessed from the operating system via an application program interface (API).

7. The method of claim 1, wherein determining the occurrence of a trigger comprises:
comparing the context data to one or more instances of previously classified context data;
assigning at least one classification of the previously classified context data to the context data; and
determining the occurrence of the trigger based, at least in part, upon the assigned classification.

8. The method of claim 7, wherein the previously classified context data is classified via manual tagging.

9. The method of claim 7, wherein the previously classified context data is classified via machine learning.

10. The method of claim 1, wherein the utilizing comprises:
applying reward logic to the context data and at least one purchase datum to determine a reward.

11. The method of claim 10, wherein the reward logic comprises an equation.

12. The method of claim 11, wherein the reward logic is defined via machine learning.

13. The method of claim 1, further comprising transmitting the reward to the mobile device wherein a time of the transmitting is based, at least in part, on the context data.

14. The method of claim 1, further comprising transmitting the reward to the mobile device as one or more of a visual message, an audio message, and a tactile message based on mobile device sensor data detected contemporaneously with a time for presenting the reward to the user of the mobile device.

15. A method comprising:
deriving, at a mobile device, context data from data captured by a plurality of sensors of the mobile device;
determining the occurrence of a trigger based, at least in part, upon the derived context data;
transmitting the context data, and data indicative of a user of the mobile device to a server configured to associate the context data with archived transaction data of the user;
receiving, as a result of the trigger occurrence a reward from the server wherein the reward is based, at least in part, upon the association of the context data with at least one transaction of the archived transaction data; and
communicate the reward to the user.

16. The method of claim 15, wherein the plurality of sensors is selected from the group consisting of a location sensor, a motion sensor, an image sensor, and audio sensor, a biometric sensor, and environmental sensor and a wireless enabled sensor.

17. The method of claim 15, wherein the receiving at a mobile device comprises receiving by an application executing on the mobile device.

18. The method of claim 17, wherein the application is a long running application.

19. The method of claim 15, wherein the context data is derived, at least in part, from an operating system of the mobile device.

20. The method of claim 19, wherein the context data is accessed from the operating system via an application program interface (API).

21. The method of claim 15, wherein determining the occurrence of a trigger comprises:
comparing the context data to one or more instances of previously classified context data;
assigning at least one classification of the previously classified context data to the context data; and
determining the occurrence of the trigger based, at least in part, upon the assigned classification.

22. The method of claim 21, wherein the previously classified context data is classified via manual tagging.

23. The method of claim 21, wherein the previously classified context data is classified via artificial intelligence.

24. A system comprising:
a mobile device configured to receive context data from one or more sensors, determine the occurrence of a trigger based, at least in part, upon the context data, transmit the context data to a server and receive from the server information describing an offer for display to a user of the mobile device; and
a server configured to receive the context data from the mobile device, to combine the context data with purchase information to determine a reward and to transmit the reward to the mobile device.

25. The system of claim 24, wherein context data from the mobile device is combined with sensor-based context data from at least one other device that is associated with the user of the mobile device to determine a reward.

26. The system of claim 25, wherein context data is received one of chronologically and asynchronously from the mobile device and the at least one other device.
